(19) United States
(12) Patent Application Publication
(10) Pub. No.: US 2026/0067347 A1
(43) Pub. Date: Mar. 5, 2026

(54) STREAM MONITORING SCHEME, RELAY DEVICE, NETWORK SYSTEM, COMPUTER READABLE MEDIUM, AND MONITORING TERMINAL

(71) Applicant: Mitsubishi Electric Corporation, Tokyo (JP)

(72) Inventors: Makoto KUBOMI, Tokyo (JP); Sachiko TANIGUCHI, Tokyo (JP)

(73) Assignee: Mitsubishi Electric Corporation, Tokyo (JP)

(21) Appl. No.: 19/381,210

(22) Filed: Nov. 6, 2025

Related U.S. Application Data
(63) Continuation of application No. PCT/JP2023/022933, filed on Jun. 21, 2023.

(51) Int. Cl. H04L 65/80; H04L 65/611

(52) U.S. Cl. CPC H04L 65/80; H04L 65/611

(57) ABSTRACT

A stream monitoring scheme (11) monitors a frame identified by a stream. A frame monitoring unit (106) monitors each stream group of multiple stream groups at an interval of a monitoring time with using a frame reception number storage unit (105), and judges normal or anomaly of a number of received frames received during the monitoring time based on a number of received frames received during the monitoring time and an expected value. The frame reception number storage unit (105) stores a reception number of received frames for each single stream group or for each stream group of the multiple stream groups where a single stream or multiple streams belong to each stream group. The frame monitoring unit (106) corrects a lower limit value and upper limit value of the expected value based on a past history of the number of received frames received during the monitoring time.

### CROSS REFERENCE TO RELATED APPLICATION

This application is a Continuation of PCT International Application No. PCT/JP2023/022933, filed on June 21, 2023, which is hereby expressly incorporated by reference into the present application.

### TECHNICAL FIELD

The present disclosure relates to a stream monitoring scheme, a relay device, a network system, a stream monitoring method, a stream monitoring program, and a monitoring terminal.

### BACKGROUND ART

In a CAN or Ethernet network, a monitoring method is available which periodically monitors frames periodically sent from each terminal, thus detecting terminal failures or intrusions of illicit frames. Note that CAN stands for Controller Area Network.

For example, Patent Literature 1 discloses a communication monitoring method that judges anomalies in a CAN frame without using time information. In Patent Literature 1, CAN frames with the same transmission interval are grouped together as one group. Then, about each group, if one CAN frame is received within a judgment period, this case is judged to be normal. The other cases are judged as anomalies. Here, the judgment period is, for example, if three types of CAN frames A, B, C belong to a certain group, a period in which reception occurs three times.

### CITATION LIST

### Patent Literature

Patent Literature 1: JP 2020-102771 A

### SUMMARY OF INVENTION

### Technical Problem

In conventional technology, multiple types of streams are grouped as a single group, streams are identified within the group, and detection of anomalies in communication is realized for each stream. A stream refers to a series of frames which are sent from a certain source node to a certain destination node and identified by parameters such as L2 header, L3 header, transfer path, and transmission interval. Hereafter, a frame identifier equivalent to CAN ID treated in a CAN network is generally referred to as "stream". Note that ID stands for IDentifier.

In the conventional technology, there is a problem that a processing load on a processor increases in proportion to an increase in number of streams because the streams are identified and a traffic of each stream is monitored periodically.

The present disclosure aims to realize communication monitoring in units of groups with the same level of accuracy as in communication monitoring in units of streams, thereby reducing the processing load on the processor.

### Solution to Problem

A stream monitoring scheme according to the present disclosure is a stream monitoring scheme which monitors a frame identified by a stream, including: a frame identification unit to identify received frames for each single stream group or for every multiple stream groups where a single stream or multiple streams belong to each stream group; and a frame monitoring unit to monitor the single stream group or each stream group of the multiple stream groups at an interval of a monitoring time with using a frame reception number storage unit which stores a reception number of received frames for each single stream group or for each stream group of the multiple stream groups, to judge normal or anomaly of a number of received frames received during the monitoring time based on the number of received frames received during the monitoring time and an expected value, and to correct a lower limit value and upper limit value of the expected value based on a past history of the number of received frames received during the monitoring time.

### Advantageous Effects of Invention

According to the stream monitoring scheme disclosed here, it is possible to monitor communication in units of stream groups where each stream group is formed of one stream or multiple streams integrated. In comparison to monitoring in units of streams, the stream monitoring scheme according to the present disclosure can reduce memory capacity, processing load of the processor, or the scale of the arithmetic and logic circuit. Moreover, by constructing a network system with multiple relay devices equipped with the stream monitoring scheme according to the present disclosure, anomalies in each stream group of the plurality of the relay devices are collected. This makes it easier to identify, or narrow down the range of, anomalies in the network system.

### BRIEF DESCRIPTION OF DRAWINGS

FIG. 1 is a diagram illustrating a functional configuration example of a relay device related to Embodiment 1.

FIG. 2 is a diagram illustrating an example of hardware configuration of the relay device according to Embodiment 1.

FIG. 3 is a flowchart illustrating an operation example of the relay device according to Embodiment 1.

FIG. 4 is a diagram illustrating an example of a grouping rule according to Embodiment 1.

FIG. 5 is a diagram describing a procedure to correct an expected value of a number of frames received during a current monitoring time based on a number of frames received during a past monitoring time in Embodiment 1.

FIG. 6 is a diagram describing how to appropriately calculate the monitoring time in Embodiment 1.

FIG. 7 is a diagram illustrating an example of a configuration of a network system according to Embodiment 2.

### DESCRIPTION OF EMBODIMENTS

Embodiments of the present disclosure will be described hereinafter with reference to the drawings. In the drawings, the same or equivalent portions are denoted by the same reference sign. In description of the embodiments, explanation of the same or equivalent portions will be suitably omitted or simplified. Arrows in the drawings primarily indicate flows of data or flows of process. Also, the size relationship among constituent components in the following drawings may differ from the actual size. In the description of the embodiments, directions or positions such as "up", "down", "left", "right", "front", "rear", "top side", and "back side" may be indicated. These terms are used for the sake of convenience in description, and do not limit the arrangement, direction, or orientation of devices, apparatuses, parts, or the like.

### Embodiment 1

### Description of Configuration

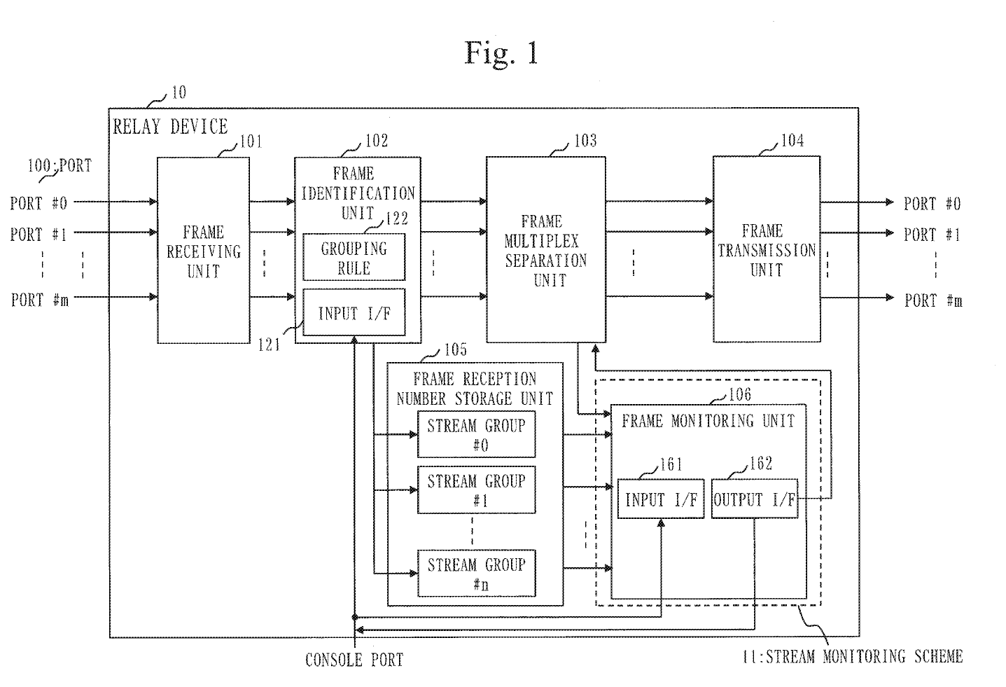

FIG. 1 is a diagram showing a functional configuration example of a relay device 10 according to the present embodiment. The relay device 10 is a node that relays frames. The relay device 10 is equipped with a stream monitoring scheme 11 that monitors the frames the relay device 10 receives. A stream refers to a series of frames which are sent from a certain source node to a certain destination node and which have parameters such as an L2 header, a header of L3 or higher, payload information, transfer route, transmission interval, frame length, burst size, priority, permissible transfer delay, and time of transfer delay fluctuation. In the present embodiment, an Ethernet network is assumed. For instance, in a CAN network, a data area to store CAN ID information is provided in the frame. Therefore, by reading the CAN ID information, it is possible to identify the frame. However, in an Ethernet frame, no such identifier data area is provided. Thus, when the relay device 10 receives a frame, it identifies the stream to which the frame belongs based on an L2 header, a header of L3 or higher, payload information, transfer route, transmission interval, frame length, burst size, priority, permissible transfer delay, and time of transfer delay fluctuation, of the frame.

The relay device 10 is equipped with ports 100, a frame receiving unit 101, a frame identification unit 102, a frame multiplex separation unit 103, a frame transmission unit 104, a frame reception number storage unit 105, and a frame monitoring unit 106. The frame identification unit 102 includes an input interface 121 and a grouping rule 122. The frame monitoring unit 106 has an input interface 161 and an output interface 162.

The frame receiving unit 101 performs an FCS check or frame length check on the frame inputted to the port 100. Note that FCS stands for Frame Check Sequence. Furthermore, if an ACL is set in the relay device, the relay device performs a check as to whether or not the inputted frame matches entries of the ACL. Note that ACL stands for Access Control List. Then, if the inputted frame matches the entries of the ACL, the relay device executes an action associated with the entries, that is, executes frame transfer or disposal.

Upon reception of the frame, the frame identification unit 102 judges which one of multiple stream groups the frame is identified to belong to, based on the grouping rule 122. Each of the multiple stream groups has a single stream or multiple streams integrated. In other words, a single or multiple streams belong to each of the multiple stream groups. The frame identification unit 102 checks the header information of the received frame matches which one of a plurality of entries corresponding to the header information of the frames that can be associated with the stream group IDs, using the grouping rule 122. For example, suppose that rules that allocate a frame to a stream group ID = 0 are MAC DA = 12 : 34 : 56 : 78 : 9A : BC and a VLAN tag with VLAN ID = 100. If the value of the MAC DA and the value of the VLAN ID of the VLAN tag of the received frame match these values, the frame is identified with stream group ID = 0. While the above description is made concerning the L2 header, the grouping rule can also use L3 or higher header or payload information, and is not limited to the L2 header. The grouping rule can be configured by a network administrator using a console port or through a network using the input interface 121. Also, the grouping rule can be included in advance in a startup program.

When the frame identification unit 102 identifies the received frame as belonging to one stream group, the frame identification unit 102 counts up a counter stored for each stream group, in the frame reception number storage unit 105. That is to say, the frame reception number storage unit 105 stores a reception number of received frames for every multiple stream groups where multiple streams belong to each of the multiple stream groups. Afterwards, the frame identification unit 102 transfers the frame to the frame multiplex separation unit 103.

The frame multiplex separation unit 103 transfers the frame to a predetermined port 100 in accordance with the frame transfer rules.

The frame transmission unit 104 holds multiple class cues for each port 100, and after allocating the frame to a corresponding class cue based on the priority of the frame, sends the frame based on a scheduling algorithm such as Strict Priority. Note that in the present embodiment, the scheduling algorithm is not particularly limited.

The stream monitoring scheme 11 includes the frame monitoring unit 106. The frame monitoring unit 106 monitors, using the frame reception number storage unit 105, each stream group of the multiple stream groups at an interval of the monitoring time. The frame monitoring unit 106 judges normal or anomaly of the number of received frames received during the monitoring time based on the number of received frames received during the monitoring time and an expected value. For instance, the frame monitoring unit 106 judges that the number of received frames received during the monitoring time is normal if the number of received frames is within an expected value range, and judges that the number of received frames is anomaly if the number of received frames is outside the expected value range. Based on the results of judgment of the normal or anomaly of the number of received frames received during the monitoring time, the frame monitoring unit 106 detects and notifies a sign of anomaly of the stream group. Alternatively, the frame monitoring unit 106 determines and notifies anomaly of the stream group if anomaly in number of received frames occurs a predetermined number of times continuously . Furthermore, the frame monitoring unit 106 corrects lower and upper limit values of the expected value based on the past history of the number of received frames received during the monitoring time.

The frame monitoring unit 106, when having judged that the number of received frames received during the monitoring time is anomaly, generates an anomaly judgment result of the stream group judged as anomaly. Then, the frame monitoring unit 106 stores the anomaly judgment result to the memory unit. Alternatively, the frame monitoring unit 106 may notify the anomaly judgment result to an outside. Notification to the outside may be displayed on a console via the console port. Alternatively, the frame monitoring unit 106 may send a frame notifying the anomaly judgment result to another device via the frame transmission unit 104. Alternatively, notification may be realized by another method.

Also, the frame monitoring unit 106 corrects the lower and upper limit values of the expected value based on the past history of the number of received frames received during the monitoring time. For example, the frame monitoring unit 106 sets the upper limit value of the expected value by a method such as setting the monitoring time to a value equal to or less than T-2α based on a frame transmission interval T and a fluctuation α of a frame reception interval. As an example of the present embodiment, a case will be described where an error due to clock deviation between the device that performs stream monitoring and the stream transmitting terminal is included in 2α. An error due to clock deviation is an error between the frame transmission interval T recognized by the device conducting stream monitoring recognizes as prior information and the actual interval with which a stream transmitting terminal sends frames.

Specifically, this is as follows. The frame monitoring unit 106 periodically reads the counter of each stream group of the frame reception number storage unit 105, compares the counter value with the expected value of the number of received frames of each stream group. If the counter value is within the expected value range, the frame monitoring unit 106 judges that the counter value is normal; if not, anomaly. When the counter value is judged to be anomaly, the frame monitoring unit 106 either retains the anomaly judgment result, or generates a frame notifying of the anomaly judgment result and sends the frame via the output interface 162. The network administrator sets parameters necessary for stream monitoring, by using the console port or from the frame receiving unit 101 through the network, via the input interface 161 of the frame monitoring unit 106. The parameters necessary for stream monitoring refer to parameters such as, for example, the transmission interval of frames in each stream and allowable fluctuation in the reception interval.

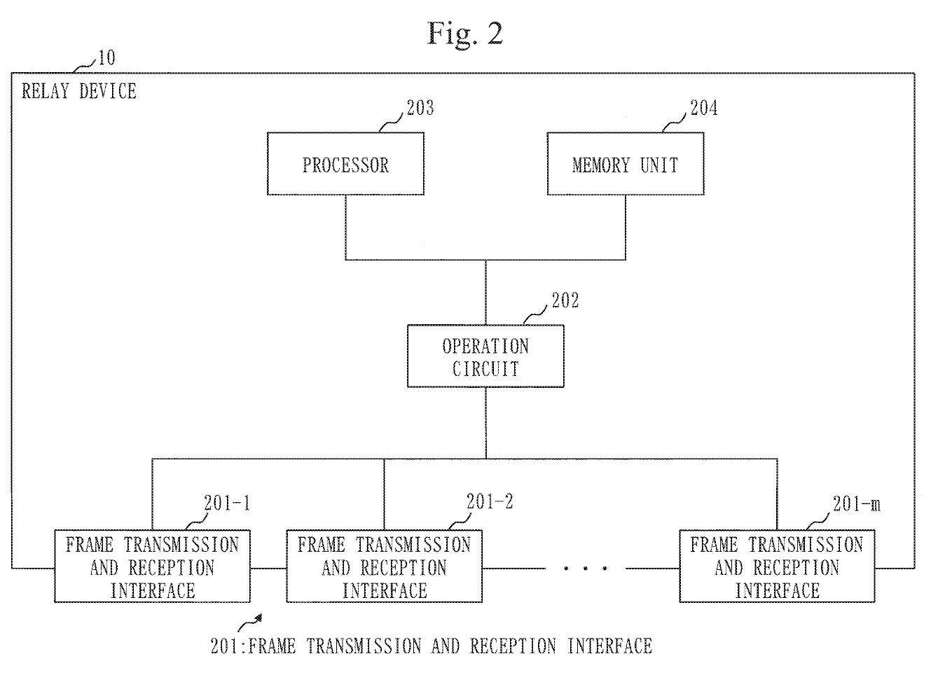

FIG. 2 is a diagram showing an example of hardware configuration of the relay device 10 according to the present embodiment. As shown in FIG. 2, the relay device 10 is equipped with frame transmission and reception interfaces 201, an operation circuit 202, a processor 203, and a memory unit 204.

FIG. 2 illustrates m units of frame transmission and reception interfaces 201 which are the frame transmission and reception interface 201-1 to the frame transmission and reception interface 201-m. Each port 100 in FIG. 1 is configured by one frame transmission and reception interface 201 of FIG. 2. The frame transmission and reception interface 201 may include an interface having a function of a PHY of the electric interface and a function of an SFP of the optical interface. Furthermore, the frame transmission and reception interface 201 may include an RJ45 connector or an M12 connector.

The operation circuit 202 is implemented by an ASIC or an FPGA circuit. Note that ASIC is short for Application Specific Integrated Circuit and that FPGA is short for Field Programmable Gate Array.

The processor 203 is a CPU, a system LSI, or the like. Note that CPU is short for Central Processing Unit and that LSI is short for Large Scale Integration.

The memory unit 204 is a RAM, a ROM, a CAM, a tCAM, or the like. Note that RAM is short for Random Access Memory; ROM for Read Only Memory; CAM for Content Addressable Memory; and tCAM for Ternary CAM.

The frame receiving unit 101, the frame multiplex separation unit 103, and the frame transmission unit 104 of FIG. 1 are implemented by the operation circuit 202. The frame identification unit 102 is implemented by the operation circuit 202, the processor 203, and the memory unit 204. The frame reception number storage unit 105 is implemented by the memory unit 204.

The frame monitoring unit 106 is implemented by the operation circuit 202, the processor 203, and the memory unit 204. A stream monitoring program that realizes the function of the frame monitoring unit 106 is loaded into the operation circuit 202 or the processor 203 and is executed by the operation circuit 202 or the processor 203. The term "unit" in the frame identification unit 102 and frame monitoring unit 106 may be replaced with "circuit", "stage", "procedure", "process", or "circuitry". The stream monitoring program causes a computer to execute a stream monitoring process. The term "process" in the stream monitoring process may be replaced with "program", "program product", "program-stored computer readable storage medium", or "program-recorded computer readable recording medium". A stream monitoring method is a method carried out as the relay device 10 executes the stream monitoring program. The stream monitoring program may be stored in a computer readable recording medium and provided. The stream monitoring program may be provided as a program product.

The processor 203, the operation circuit 202, and the memory unit 204 are also referred to as processing circuitry. In other words, the functions of the relay device 10 in FIG. 1 are implemented by the processing circuitry. Additionally, the processor 203 and the operation circuit 202 may be collectively referred to as processing circuitry, and the functions of the relay device 10 in FIG. 1 may implemented by the processing circuitry and the memory unit 204.

### Description of Operation

Next, the operation of the relay device 10 according to the present embodiment will be described. An operation procedure of the relay device 10 corresponds to the stream monitoring method.

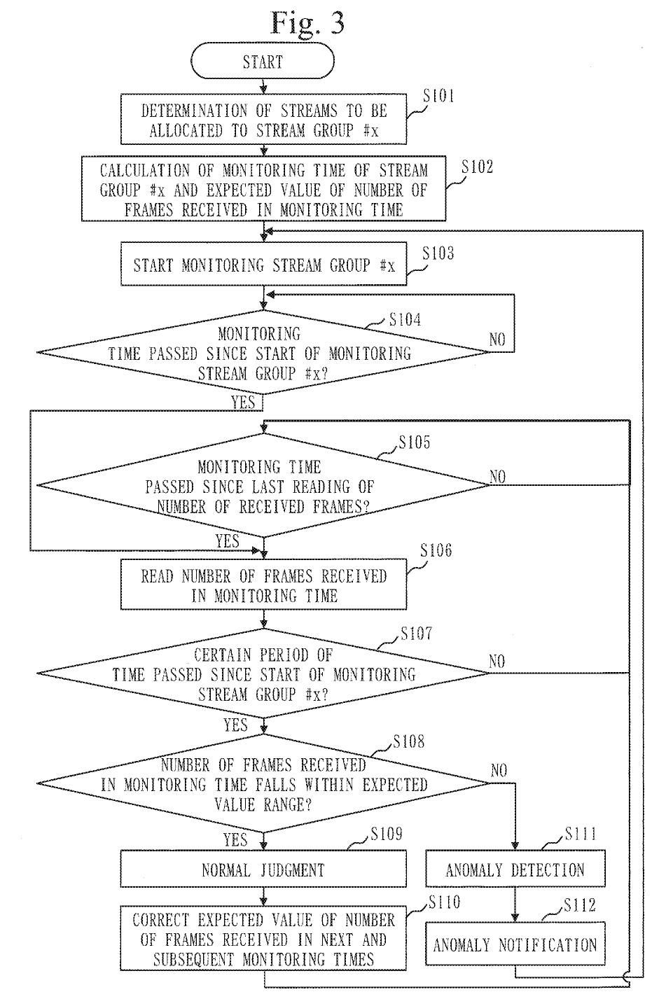

FIG. 3 is a flowchart showing an operation example of the relay device 10 according to the present embodiment. Referring to FIG. 3, the procedure for periodically monitoring the stream groups in the relay device 10 will be described. Hereinafter, a stream group being a target of periodic monitoring is referred to as a stream group #x.

In step S101, streams to be allocated to each stream group are determined. Which streams are allocated to which stream groups are determined by the grouping rule 122.

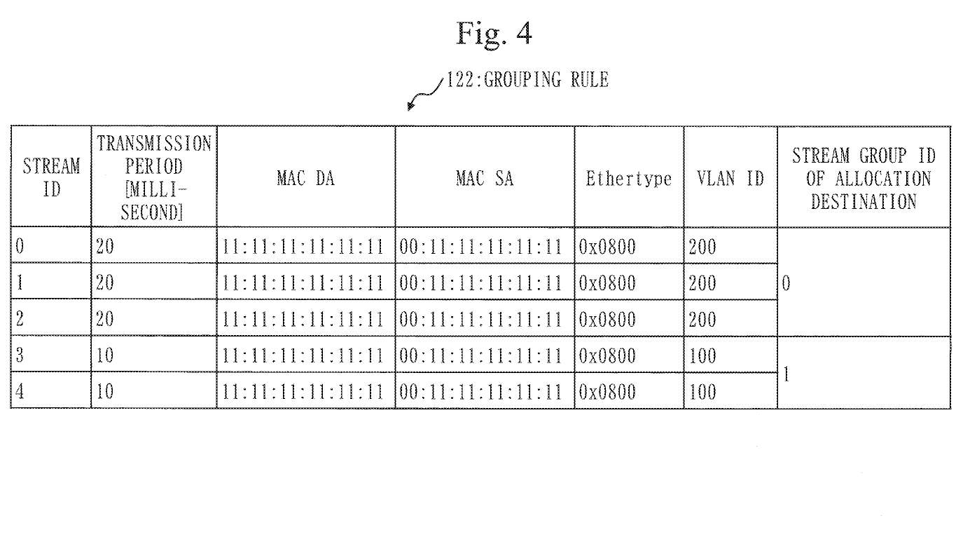

FIG. 4 is a diagram illustrating an example of the grouping rule 122 according to the present embodiment. In FIG. 4, the grouping rule 122 sets a stream ID identifying a stream, a transmission interval of a frame on the stream, header information, and a stream group ID of an allocation destination. Examples of the header information include MAC DA, MAC SA, Ethertype, and VLAN ID. The grouping rule 122 is not limited to this, and information such as a header of L3 or higher, a payload, and reception port information may be included in stream identification. In the stream monitoring scheme, it is necessary that the transmission intervals of the streams allocated to each stream group are identical, and the grouping rule 122 needs to satisfy this condition. Also, a criteria may be provided, in addition to the transmission interval information, for allocating streams with the same or nearly the same allowable delay, the same or nearly the same delay fluctuation time, and so on to the same stream group. The frame identification unit 102 refers to the grouping rule 122 to determine which frame on each stream should be allocated to which stream group. Specifically, the frame identification unit 102 identifies a single stream, multiple streams with the same stream transmission interval, or multiple streams with transmission intervals different from each other by 2α or less where α is a fluctuation of the frame reception interval, as one stream group.

In step S102, the frame monitoring unit 106 calculates a monitoring time of a stream group #x, and an expected value of a number of frames received within the monitoring time. The specific calculation methodology will be described later.

In step S103, the frame monitoring unit 106 starts monitoring the stream group #x. In step S104, the frame monitoring unit 106 judges whether a monitoring time has passed since the start of monitoring the stream group #x. When the monitoring time has passed since the start of monitoring the stream group #x, the frame monitoring unit 106 proceeds to step S106. If the monitoring time has not passed since the start of monitoring the stream group #x, the frame monitoring unit 106 repeats step S104 until the monitoring time passes.

In step S106, the frame monitoring unit 106 reads the number of received frames of the stream group #x within the monitoring time. In step S107, the frame monitoring unit 106 judges whether a certain period of time has passed since the start of monitoring the stream group #x. If the certain period of time has passed since the start of monitoring the stream group #x, the frame monitoring unit 106 proceeds to step S108. If the certain period of time has not passed since the start of monitoring the stream group #x, the frame monitoring unit 106 proceeds to step S105.

In step S105, the frame monitoring unit 106 judges whether a monitoring time has passed since the last reading of the number of received frames. When the monitoring time has passed since the last reading of the number of received frames, the frame monitoring unit 106 proceeds to step S106. If the monitoring time has not passed since the last reading of the number of received frames, the frame monitoring unit 106 repeats step S105 until the monitoring time passes. In other words, the frame monitoring unit 106 repeatedly reads the number of received frames of the stream group #x during the monitoring time, when the monitoring time has passed since the last reading of the number of received frames, until a certain period of time passes after the start of monitoring the stream group #x. Here, the certain period of time refers to a time necessary for fully accumulating the past histories of the number of frames received in each monitoring time.

In step S108, the frame monitoring unit 106 judges whether or not the number of frames received within the monitoring time falls within the expected value range. If the number of received frames within the monitoring time falls within the expected value range (YES at step S108), the frame monitoring unit 106 proceeds to step S109, and judges that the stream group #x in that monitoring time is normal. Then, in step S110, the frame monitoring unit 106 corrects the expected value of the number of frames received in the next and subsequent monitoring times based on the past history of the number of frames received within the monitoring time. After that, the frame monitoring unit 106 returns to step S105.

If the number of frames received during the monitoring time does not fall within the expected value range (NO at step S108), the frame monitoring unit 106 proceeds to step S111, and judges that the stream group #x in that monitoring time is anomaly. Then, in step S112, the frame monitoring unit 106 generates an anomaly notification frame notifying of the anomaly, and sends the anomaly notification frame via the output interface 162. Alternatively, the frame monitoring unit 106 may internally retain an anomaly judgment result of the stream group #x as a log. Note that notification of anomaly judgment results and retention of logs may be implemented each time anomaly is detected in each stream group. Alternatively, anomaly notification may be implemented in each stream group on condition that not less than a certain number of anomalies are detected within a certain period of time. As mentioned above, the criteria for determining that anomaly or failure has occurred in the network system from the anomaly detection of the stream are not particularly limited. Subsequently, the frame monitoring unit 106 returns to step S103, and restarts the monitoring of the stream group #x in order to reset the past history of the number of frames received during each monitoring time.

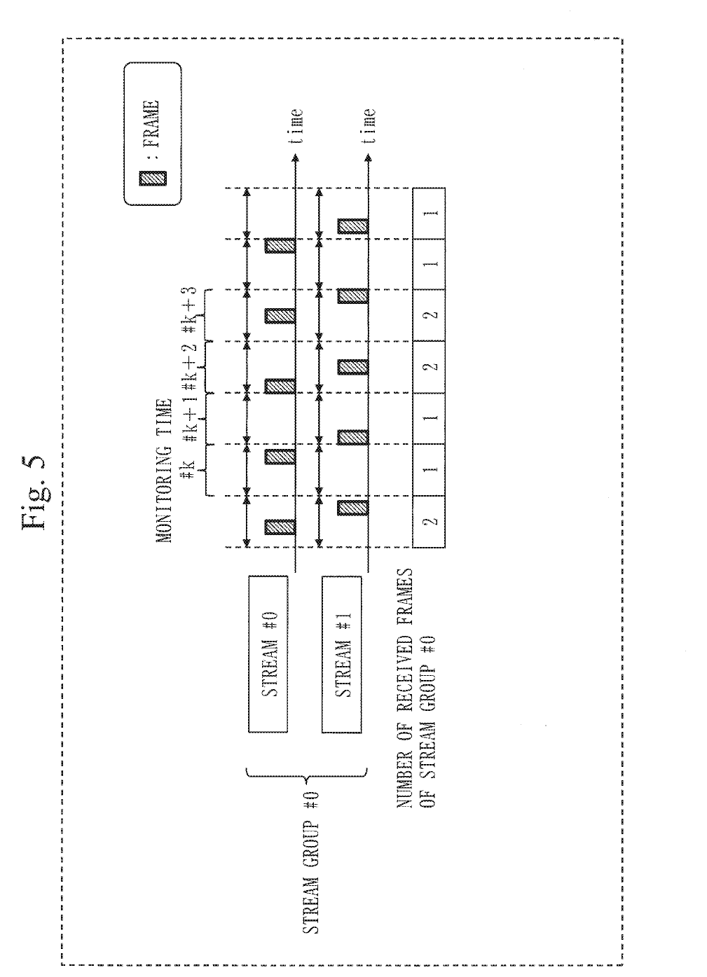

FIG. 5 is a diagram that describes a procedure to correct the expected value of the number of frames received in the current monitoring time based on the number of frames received in the past monitoring time in the present embodiment.

In FIG. 5, a stream #0 and a stream #1 having the same transmission interval are allocated to the stream group #0. Although the parameter of the stream is the transmission interval, for the frame monitoring unit 106, the parameter is the reception interval. FIG. 5 represents the frame reception timing taken along the time axis of each stream and the number of received frames of the stream group #0 within each monitoring time.

FIG. 5 demonstrates an example in which the monitoring time is set shorter than the transmission interval of the stream so that both the stream #0 and the stream #1 are received in a pattern of "1→1→1→0 (then, repeated)" for each monitoring time. The monitoring time #k will now be focused on. In the monitoring time #k, the number of received frames of the stream group #0 is "1", so it is determined that the number of receptions of either stream is "0", and that the number of receptions of either stream is "1" in the three subsequent monitoring times. The three subsequent monitoring times are #k+1, #k+2, and #k+3. That is, in the three subsequent monitoring times (#k+1, #k+2, and #k+3), the number of received frames of the stream group #0 is at least "1", so the lower limit value of the expected value of the number of received frames of the stream group #0 can be set to "1".

If the history of the number of past received frames is not referred to, the expected value of the number of received frames of each stream is "0 or 1". In the example of FIG. 5 where two streams are integrated, the expected value of the number of received frames from the stream group #0 is "0 or 1 or 2". Hence, the lower limit value is "0". By referring to the history of the number of past received frames as described above, the width of the expected values can be corrected to be narrow.

The above is an example of correcting the lower limit value, but it is also possible to correct the upper limit value by utilizing the fact that the number of received frames becomes zero only once for each interval of the stream reception pattern. As mentioned above, in FIG. 5, the number of received frames is "0" once per four monitoring times of "1→1→1→0". The upper limit value may also be corrected in this manner. In addition, the upper limit value can be corrected by a procedure similar to that described above, if the monitoring time is set longer than the stream interval so that the pattern of the number of received frames of the stream becomes basically "0", as with the pattern "0→0→0→1" of the number of received frames of the stream.

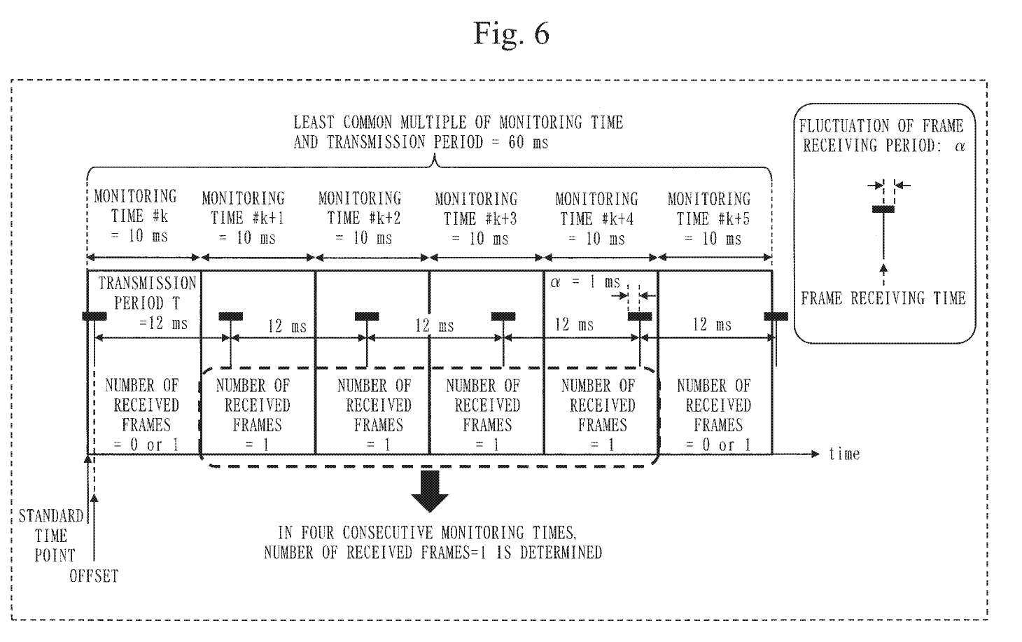

FIG. 6 is a diagram that describes how to appropriately calculate the monitoring time in the present embodiment. When the monitoring time is set to "T-2α" or less by using the transmission interval T of the stream allocated to the stream group and by using the fluctuation α of the stream's reception interval, a monitoring time where the number of received frames is always "1" can be caused to occur consecutively a predetermined number of times. FIG. 6 shows an example where the monitoring time is set to "T-2α" and resultantly the number of received frames is determined in consecutive monitoring times. In FIG. 6, the transmission interval T is T = 12 ms and the reception interval fluctuation α is α = 1 ms, so the monitoring time is 10 ms. It may be possible to set a monitoring time shorter than "T-2α". However, if the monitoring time is short, a processing load of the processor may increase, which is advantageous. Therefore, it is desirable to set the monitoring time to "T-2α". It may also be possible to set a time longer than "T-2α". In that case, the number of received frames which is determined for monitoring times that are consecutive a predetermined number of times will be "2 or more" instead of "1". Accordingly, the stream receiving pattern (in FIG. 5, "1→1→1→0") becomes different from a case where the monitoring time is "T-2α". This should be taken into consideration. Also, it is assumed that when the stream is normal, the frame identification unit 102 receives frames during each time segment of 2α of FIG. 6. In FIG. 6, the monitoring time occurs six times (60 ms ÷ 10 ms = 6) within 60 ms which is a time as a least common multiple of the monitoring time and T. Identifiers #k to #+5 are set for the monitoring times respectively. In FIG. 6, in the monitoring time #k and monitoring time #k+5 , the frame reception fluctuation width 2α is located on the boundary, and it is not determined whether the number of received frames is 0, or 1. On the other hand, in the four monitoring times which are the monitoring times #k+1 to #k+4, the frame reception fluctuation width 2α stays within each monitoring time, so it is determined that the number of received frames is 1. Note that a start time point of the monitoring time #k is determined as a standard time point, and that the reception time point of a frame that is received the first after the standard time point is determined as offset. At this time, if the three parameters (the monitoring time, the transmission interval T, and the reception interval fluctuation α) mentioned above are determined, the predetermined consecutive number of times (four times in FIG. 6) within the monitoring time where the number of received frames is always "1" is not dependent on the offset.

Also, when the frame length of a stream allocated to a certain stream group differs, if the number of bytes of the received frame within the same monitoring time interval is also monitored, in addition to the aforementioned monitoring of the number of received frames in units of stream groups, then it is possible to identify a stream within a stream group in which anomaly has occurred. For instance, assuming that in FIG. 5 the frame lengths of streams with stream ID = 0 and stream ID = 1 are 100 bytes and 200 bytes, respectively, the number of received bytes during the monitoring time #k is 100 bytes. As stated in FIG. 5, since the number of received frames during the monitoring time #k is 1, a stream that was not received during the monitoring time #k can be identified as the stream #1. Herein, assume a case where the number of received frames of the stream group #0 during the monitoring time #k+1 is 0. As described above, in a normal case, the number of received frames of the stream #1 is always "1" in the monitoring times #k+1 to #k+3. Therefore, it is possible to judge that anomaly occurs in the stream #1. When a stream where anomaly has occurred is identified in the above manner, the anomaly judgment result is retained or notified together with the ID of the stream group which is judged to be an anomaly and the ID of the stream. As described above, the frame monitoring unit 106 also performs monitoring of a number of bytes of the received frames by the same interval of the monitoring time, in addition to monitoring of the number of received frames in units of stream groups which is performed by an interval of the monitoring time. Alternatively, when the frame monitoring unit 106 has judged that the number of received frames received during the monitoring time is anomaly, the frame monitoring unit 106 checks the number of bytes of the received frames received within the monitoring time.

### Description of Effect of the Embodiment

As stated above, the relay device according to the present embodiment has a stream monitoring scheme which monitors a stream group formed of a single stream or multiple streams integrated, at regular intervals of monitoring time. The relay device judges that the number of frames received during the monitoring time is normal if the number is within the expected value range; otherwise, anomaly. Also, this stream monitoring scheme corrects, based on the history of the number of received frames in the past monitoring times, the lower and upper limit values of the expected value of the number of frames received during a certain number of subsequent monitoring times. Therefore, the relay device according to the present embodiment enables monitoring of communication in units of stream groups where each stream group is formed of a single stream or multiple streams integrated, and can reduce the processing load of the processor compared to monitoring in units of streams.

Furthermore, the relay device according to the present embodiment corrects the lower and upper limit values of the expected value based on the history of the number of frames received during the past monitoring times. Therefore, the relay device according to the present embodiment, while maintaining the same level of accuracy as the communication monitoring in units of streams without degrading the precision of anomaly detection, can realize reduction in processing load of the processor resulting from the communication monitoring in units of groups.

In Embodiment 1 above, each part of the relay device is described as an independent function block. However, the described configuration of the relay device is just one example, and the relay device need not be configured in the way mentioned in the above embodiment. Any configuration of the function blocks of the relay device would be acceptable as long as it can realize the functions described in the above embodiment. Furthermore, of Embodiment 1, multiple parts can be implemented by combination. Also, it is acceptable to implement only one part of the present embodiment. Besides, the present embodiment can be implemented in any combination, either whole or in part. In other words, in Embodiment 1, free combination of parts of the embodiment, modification of any component of the embodiment, or omission of any component in the embodiment is possible.

### Embodiment 2

In the present embodiment, primarily, respects differing from Embodiment 1 and respects to be added to Embodiment 1 are described. In the present embodiment, components having the same function as in Embodiment 1 are denoted by the same reference sign, and their explanations are omitted.

In the present embodiment, a network system 500 equipped with multiple relay devices 10 described in Embodiment 1 will be described. As the network system 500, a system will be described that identifies locations where stream anomalies are detected, by sharing stream monitoring results 61 among the relay devices 10, or by integrating, with a monitoring terminal connected to the network, the stream monitoring results 61 that are sent by the relay devices 10. In the present embodiment, a frame monitoring unit 106 generates a judgment result of normal or anomaly of the number of received frames, as the stream monitoring result 61 of each stream group. Then, the frame monitoring unit 106 sends the stream monitoring result 61 to at least one of a plurality of the relay devices. In other words, the stream monitoring results 61 of the stream groups are integrated in one relay device.

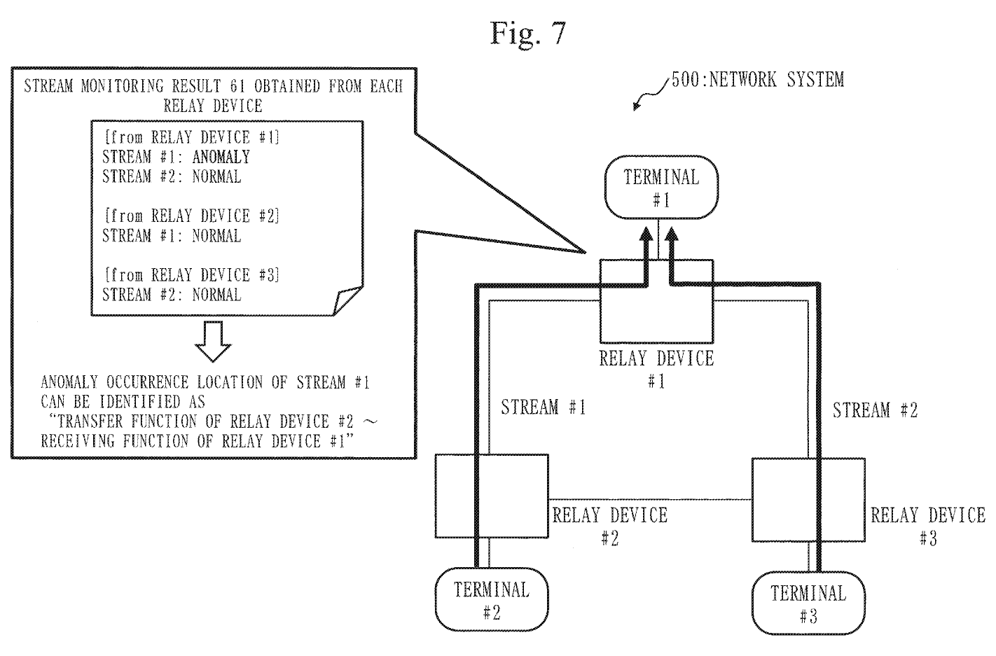

FIG. 7 is a diagram illustrating a configuration example of the network system 500 according to the present embodiment. The network system 500 includes the plurality of relay devices 10. In the example of FIG. 7, the network system 500 includes a relay device #1, a relay device #2, and a relay device #e. The configuration of each relay device is the same as that described in Embodiment 1.

FIG. 7 shows an example where the relay device #1 has collected the stream monitoring results 61 from the relay device #2 and the relay device #3. The stream monitoring results 61 may be notified to the other relay devices only in case of anomalies, or may be notified regardless of normal or anomaly. Alternatively, the stream monitoring results 61 may be notified when normal has changed to anomaly or when anomaly has changed to normal. FIG. 7 shows that in the stream monitoring result 61 of the relay device #1 itself, stream #1 is set as anomaly, and stream #2 is set as normal. In the stream monitoring result 61 of the relay device #2, stream #1 is set as normal. In the stream monitoring result 61 of the relay device #3, stream #2 is set as normal. The relay device #1 has collected these three sets of stream monitoring results 61.

It can be judged that in the relay device #1, the stream #1 was normal until reaching a frame identification unit 102 of the relay device #2 but anomaly occurred in the stream #1 in a section from a frame multiplex separation unit 103 of the relay device #2 to a frame identification unit 102 of the relay device #1 itself. This judgment result may be kept within the relay device #1 or may be notified externally from an output interface 162 of the frame monitoring unit 106. In addition, stream monitoring result notification frames from other relay devices are transferred from the frame multiplex separation unit 103 to the frame monitoring unit 106. Integration of the stream monitoring results and identification of a location where the stream anomaly has occurred, which are mentioned above, may be carried out by each relay device as stated above, or may be carried out by other monitoring terminals connected to the network.

After identifying the location where the stream anomaly has occurred, the relay device may change a stream transfer route that includes the occurrence location in it, to a transfer route that bypasses the occurrence location. To change the location of occurrence to the transfer route that bypasses the location of occurrence, the relay device may change the transfer processing settings of each stream of the relay device. Alternatively, the relay device may limit the bandwidth of the stream judged to be anomaly. Also, in order to discard a stream judged to be anomaly, the relay device may change the transfer processing settings of each stream of the relay device. Furthermore, the process to cope with the stream anomalies as described above may be carried out individually by each relay device. Alternatively, another monitoring terminal may decide the coping process, may notify the relay device of the decided content, and may change the settings of the relay device, thereby executing the coping process.

### Description of Effect of the Embodiment

As described above, the network system according to the present embodiment can identify a location where stream anomaly has occurred, in addition to having the effect of Embodiment 1. Based on information of the location where the stream anomaly has occurred, it is possible to change the stream transfer route that includes the occurrence location in it, to a transfer route that bypasses the occurrence location, may limit the bandwidth of the stream judged to be an anomaly, or may carry out controls of the relay devices that are necessary for the operation of the network system so as to discard the stream judged to be anomaly.

The aforementioned Embodiment 1 and Embodiment 2 are essentially preferable exemplifications, and are not intended to limit the scope of the present disclosure, the scope of the applied product of the present disclosure, and the scope of usage of the present disclosure. The embodiments described above can be modified in various ways as necessary. For example, the procedure described using a flowchart or sequence diagram can be modified appropriately.

### REFERENCE SIGNS LIST

10: relay device; 11: stream monitoring scheme; 60: anomaly notification; 61: stream monitoring result; 100: port; 101: frame receiving unit; 102: frame identification unit; 103: frame multiplex separation unit; 104: frame transmission unit; 105: frame reception number storage unit; 106: frame monitoring unit; 121,161: input interface; 122: grouping rule; 162: output interface; 201: frame transmission and reception interface; 202: operation circuit; 203: processor; 204: memory unit; 500: network system.

1. A stream monitoring scheme comprising:
processing circuitry
to identify a received frame and determine which stream group the received frame is to be allocated to, and
to monitor a single stream group or multiple stream groups at an interval of a monitoring time calculated based on a transmission interval of and a fluctuation of a reception interval of a frame to be allocated to the single stream group or the multiple stream groups, with using a memory which stores a reception number of received frames for the single stream group or for the multiple stream groups, to judge normal or anomaly of a number of received frames received during the monitoring time based on the number of received frames received during the monitoring time and an expected value calculated based on the transmission interval of the frame and the monitoring time, and to correct a lower limit value and upper limit value of the expected value based on a past history of the number of received frames received during the monitoring time.

2. The stream monitoring scheme according to claim 1,
wherein the processing circuitry identifies a single stream, multiple streams with the same stream transmission interval, or multiple streams with transmission intervals different from each other by 2α or less where α is a fluctuation of a frame reception interval, as one stream group.

3. The stream monitoring scheme according to claim 1,
wherein the processing circuitry judges that the number of received frames received during the monitoring time is normal if the number of received frames is within an expected value range, and judges that the number of received frames is anomaly if the number of received frames is outside the expected value range.

4. The stream monitoring scheme according to claim 1,
wherein the processing circuitry sets the monitoring time to a value equal to or less than T-2α based on a frame transmission interval T and a fluctuation α of a frame reception interval.

5. The stream monitoring scheme according to claim 1,
wherein the processing circuitry also performs monitoring of a number of bytes of the received frames by the same interval of the monitoring time, in addition to monitoring of the number of received frames in units of stream groups which is performed by an interval of the monitoring time; or when having judged that the number of received frames received during the monitoring time is anomaly, checks the number of bytes of the received frames received within the monitoring time.

6. The stream monitoring scheme according to claim 1,
wherein the processing circuitry, when having judged that the number of received frames received during the monitoring time is anomaly, generates an anomaly judgment result of each stream group.

7. The stream monitoring scheme according to claim 6,
wherein the processing circuitry stores the anomaly judgment result to a memory.

8. The stream monitoring scheme according to claim 6,
wherein the processing circuitry notifies the anomaly judgment result to an outside.

9. A relay device which relays a frame identified by a stream, comprising:
a memory to store a reception number of received frames for each single stream group or for every multiple stream groups where a single stream or multiple streams belong to each stream group; and
the stream monitoring scheme according to claim 1.

10. A network system comprising a plurality of relay devices which relay a frame identified by a steam,
each relay device of the plurality of relay devices comprising:
a memory to store a reception number of received frames for each single stream group or for every multiple stream groups where a single stream or multiple streams belong to each stream group; and
the stream monitoring scheme according to claim 1.

11. The network system according to claim 10,
wherein the processing circuitry generates a judgment result of normal or anomaly of the number of received frames, as a stream monitoring result of each stream group, and sends the stream monitoring result to at least one of the plurality of the relay devices, or to a monitoring terminal that integrates stream monitoring results of the relay devices.

12. A non-transitory computer readable medium storing a stream monitoring program employed by a relay device which relays a frame identified by a stream, the program causing a computer to execute:
a frame identification process of identifying received frames for each single stream group or for every multiple stream groups where a single stream or multiple streams belong to each stream group; and
a frame monitoring process of monitoring the single stream group or each stream group of the multiple stream groups at an interval of a monitoring time with using a memory which stores a reception number of received frames for each single stream group or for each stream group of the multiple stream groups, judging normal or anomaly of a number of received frames received during the monitoring time based on the number of received frames received during the monitoring time and an expected value, and correcting a lower limit value and upper limit value of the expected value based on a past history of the number of received frames received during the monitoring time.

13. A relay device which integrates stream monitoring results sent by a plurality of relay devices provided with the stream monitoring scheme according to claim 1, and identifies a location where anomaly has occurred in a network.

14. A monitoring terminal which integrates stream monitoring results sent by a plurality of relay devices provided with the stream monitoring scheme according to claim 1, and identifies a location where anomaly has occurred in a network.
